(19) United States
(12) Patent Application Publication
(10) Pub. No.: US 2014/0083177 A1
(43) Pub. Date: Mar. 27, 2014

(54) System For Logging While Running Casing

(71) Applicants: Robert Utter, Sugar Land, TX (US); Gbenga Onadeko, Sugar Land, TX (US); Alexis Husser, New Orleans, LA (US)

(72) Inventors: Robert Utter, Sugar Land, TX (US); Gbenga Onadeko, Sugar Land, TX (US); Alexis Husser, New Orleans, LA (US)

(73) Assignee: SCHLUMBERGER TECHNOLOGY CORPORATION, Sugar Land, TX (US)

(21) Appl. No.: 14/001,876

(22) PCT Filed: Feb. 28, 2012
(86) PCT No.: PCT/US2012/026965

§ 371 Date: Dec. 9, 2013

Related U.S. Application Data
(60) Provisional application No. 61/447,288, filed on Feb. 28, 2011.

(51) Int. Cl. G01V 11/00

(52) U.S. Cl. CPC G01V 11/002
USPC 73/152.43

(57) ABSTRACT

A well logging while casing instrument system includes a segment of pipe having at least one window therein corresponding to selected well logging instrument sensors. The segment of pipe has at least one of a float collar, a reaming shoe or a casing drill bit attached to one end thereof. At least one well logging instrument is disposed inside the segment of pipe. The at least one well logging instrument includes at least one sensor disposed at longitudinal position corresponding to the at least one window. The at least one well logging instrument includes a fishing neck at one longitudinal end thereof to enable retrieval of the at least one well logging instrument from the interior of the segment of pipe.

### BACKGROUND OF THE INVENTION

1. Field of the Invention

The invention relates generally to the field of measurement of subsurface formation properties from within wellbores drilled through such formations. More specifically, the invention relates to systems for making such measurements during the insertion into a wellbore of a protective pipe of casing.

2. Background Art

Using “well logging” instruments to evaluate the formations surrounding a given wellbore drilled through subsurface formations is a common practice. Well logging is performed by moving instruments having selected sensors along the interior of a wellbore to obtain data concerning the physical properties of the formations surrounding the wellbore. Various techniques are well known in the art for conveying such instruments along the interior of a wellbore. Such well logging operations may be performed through all stages of development of a particular subsurface reservoir to reduce uncertainty, improve efficiency, and maximize production of economically valuable materials, e.g., hydrocarbons.

The value of well logging data acquired is related to how much uncertainty exists in the development of any particular subsurface reservoir, but the economics of many reservoir development projects are not conducive to well logging techniques known in the art. “Intrusive” in the present context may mean any well logging technique where significant additional non-drilling time on a drilling unit is required to complete the well logging operation. Logging-while-drilling (LWD) is used in many cases because it enables obtaining well logging measurements without the consumption of additional rig time to acquire the well logging data. The actual and risked cost of LWD services however, in situations that do not justify the expense of LWD operations, compels the wellbore operator to forego obtaining LWD data. For these reasons there are still a large number of wellbores that are not logged in any fashion. In particular, of the 17,000 wells drilled yearly in North America only about three percent have well logging or “formation evaluation data” of any kind acquired.

There exists a need for additional techniques to obtain well logging data that are more economical than techniques known in the art.

### SUMMARY OF THE INVENTION

A well logging while casing instrument system according to one aspect of the invention includes a segment of pipe having at least one window therein corresponding to selected well logging instrument sensors. The segment of pipe has at least one of a float collar, a reaming shoe or a casing drill bit attached to one end thereof. At least one well logging instrument is disposed inside the segment of pipe. The at least one well logging instrument includes at least one sensor disposed at longitudinal position corresponding to the at least one window. The at least one well logging instrument includes a fishing neck at one longitudinal end thereof to enable retrieval of the at least one well logging instrument from the interior of the segment of pipe.

A method for well logging according to another aspect of the invention includes inserting at least one well logging instrument into an interior of a segment of a wellbore pipe. The pipe has at least one window therein corresponding to a longitudinal position of a sensor on the at least one well logging instrument. The pipe is inserted into a wellbore drilled through subsurface formations to a selected depth therein. The at least one well logging instrument is operated to measure a physical property of the subsurface formations as the pipe is inserted into the wellbore. The at least one well logging instrument is retrieved from the segment of wellbore pipe when the wellbore pipe is inserted to the selected depth.

Other aspects and advantages of the invention will be apparent from the following description and the appended claims.

### BRIEF DESCRIPTION OF THE DRAWINGS

FIG. 1 shows an example system for inserting casing into a wellbore.

FIG. 2 shows an example casing or liner segment that can contain LWC instruments according to the invention.

FIG. 3 shows the example casing or liner segment of FIG. 1 with example sensors disposed proximate sensor windows described with reference to FIG. 1.

FIG. 4 shows an example well logging instrument assembly inserted into the casing segment of FIG. 2 and FIG. 3.

FIG. 5 shows an uppermost portion of the example instrument assembly shown in FIG. 4.

### DETAILED DESCRIPTION

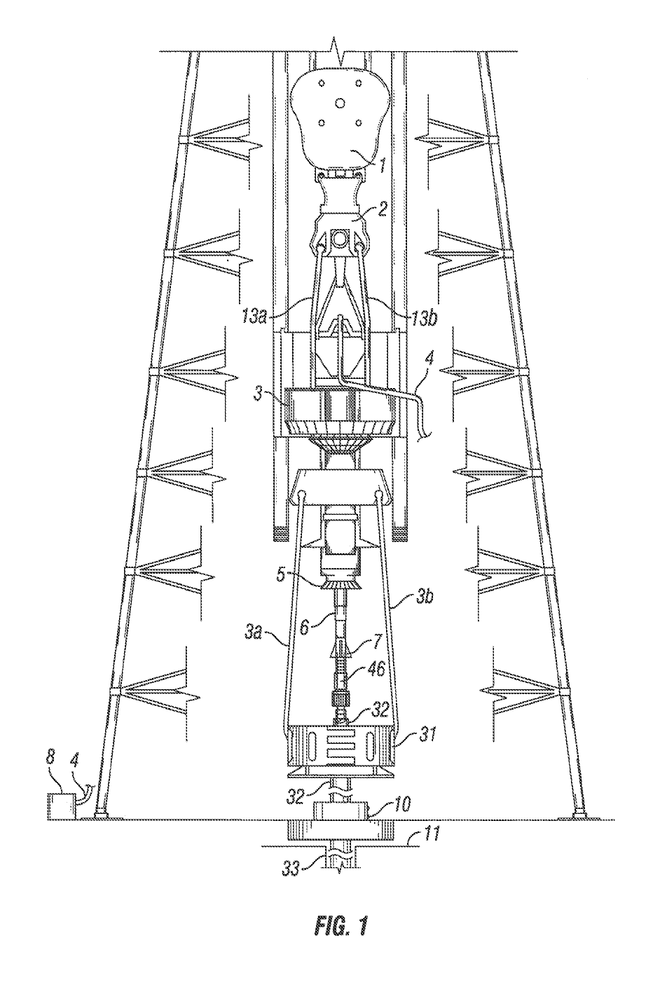

FIG. 1 shows an example drilling rig with a “top drive” 3. FIG. 1 also shows a casing fill up and circulator tool 46 in the top drive configuration. A hook 2 may be suspended from a traveling block 1 on the drilling rig. The top drive 3 is suspended from the hook 2. Pressurized fluid is typically delivered from fluid pumps 8 through a hose 4 directly to the top drive unit 3. A top sub box connection assembly 6 may be threadedly connected at one end to a top drive pin shoulder 5 to receive the fill up and circulating tool 46. The opposite end of the top sub box connection assembly 6 may be threadedly connected to the casing fill up and circulating tool 46. A tool catch plate 7 may be fixed to the top sub box connection assembly 6 as a stop which will engage the uppermost portion of a casing 32 if the circulating tool 46 becomes disengaged from the top drive 3. An elevator 31 may be suspended from bails 3a and 3b attached to the top drive 3. A joint of the casing 32 may be positioned under the top drive 3 so as to allow the upper end of the casing 32 to be gripped by the elevator 31, thereby inserting the fill up and circulating tool 46 partially inside of the casing 32. The casing 32, suspended from the elevator 31 may then be lowered through rotary table slips 10 on the drilling rig floor and a rotary table 11 below the rig floor and into the wellbore 33. As the casing 32 is being lowered it may be filled with fluid from the fill up and circulating tool 46. Once the casing 32 is lowered such that the elevator 31 is almost in contact with the rotary table slips 10, the slips 10 are then engaged against the casing 32 to hold it in position above the rig floor to receive the next joint of casing 32. The procedure is repeated until the entire casing string has been lowered into the wellbore 33.

Well logging instruments known in the art for acquiring measurements of formation physical properties from within a wellbore are typically operated prior to insertion of the casing 32 into the wellbore 33 (in “open hole”), because the physics of the various measurements generally require direct exposure of the various sensing devices to the formations outside the wellbore 33. To acquire data in open hole, the instruments are typically operated prior to setting the casing 32 in the wellbore 33. In order for such measurements to be made immediately after the drilling of the wellbore is finished, and without incurring additional time expenditure on the drilling unit, the well logging tools may be part of the casing 32, explained more fully below. Such “logging-while-casing” (LWC) operations may provide a low risk alternative to wireline, coiled tubing, drill pipe or LWD instrument conveyance without incurring additional drilling unit time expense, sacrificing data quality or development efficiency.

A LWC system may be used, as part the casing 32 (or a “liner”, which is a conduit inserted into the wellbore but which typically does not extend back to the surface), to acquire well logging data while tripping into the hole with liner or the casing 32. The LWC system, or some component parts of the LWC system, may be retrieved from inside the liner or casing 32 with wireline, slickline or coiled tubing after the liner or casing reaches the total depth intended in the wellbore prior to cementing the liner or casing in place in the wellbore.

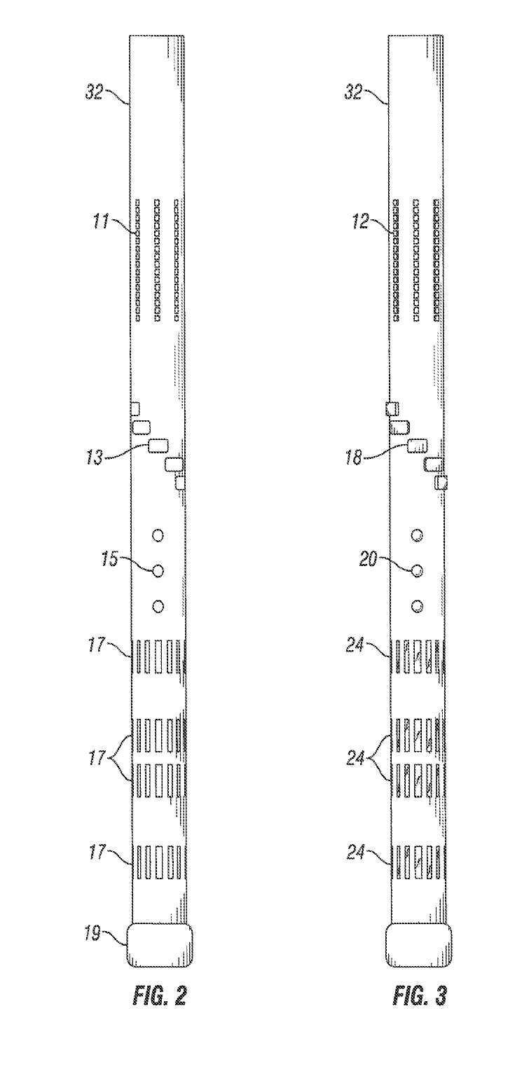

An example LWC system will now be described with reference to FIGS. 2 through 5. FIG. 2 shows an example casing or liner segment 32 that has features therein to enable well logging sensors ordinarily used in “open hole” to make measurements of the formations surrounding a wellbore. An industry standard casing or liner joint (30 foot segment) or a plurality of such joints joined by industry standard threaded connections (casing collars) can be machined to provide openings (“windows”), shown at 11, 13, 15 and 17, to accommodate the particular well logging instruments required for a specific well. Alternatively, such casing or liner segments 32 may be manufactured with appropriate “windows” in bulk quantities for “standard” well logging applications.

An open casing shoe, either with a casing drill bit, reaming shoe, float collar or bull-nose, shown generally at 19, may be affixed to the bottom of the casing segment 32. Thus, inserting the casing 32 into the wellbore (33 in FIG. 1) may include operating the casing drill bit or reaming shoe.

FIG. 3 shows the casing or liner segment 32 of FIG. 2 with one or more example well logging instruments disposed inside. Pad devices or sacrificial sensors, e.g., resistivity sensors, dielectric constant sensors or fluid extraction pads may be visible through certain of the windows, for example, as shown at 13, and may be either recessed or flush with the outer surface of the casing 32, or mounted on the outside of the casing 32. Other sensors may be disposed inside the respective windows, e.g., at 11, 15 and 17 and not protrude from the casing 32. For purposes of explaining the scope of the invention, only one well logging instrument is required to be disposed within the casing 32, and for which a corresponding feature (e.g., a window) may be formed in the casing 32. In some examples, a plurality of well logging instruments may be inserted into the casing 32. Such instruments may be coupled end to end, and for convenience well logging instruments coupled together maybe referred to as a well logging instrument “string”, as will be further explained.

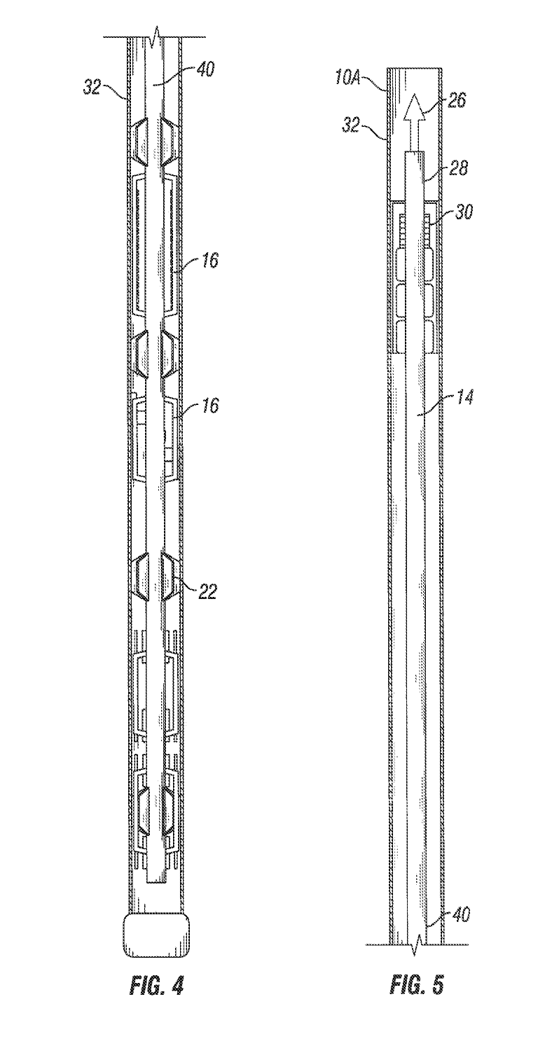

FIG. 4 shows a cut away view of the casing segment 32 having a well logging instrument string 40 disposed therein. The well logging instrument string 40 may include sensors, for example and without limitation, electromagnetic propagation or nuclear magnetic resonance sensors 24, nuclear sensors, such as gamma ray or neutron detectors 20, galvanic electrodes 18 that may be extended or retracted using a suitable mechanism 16, and acoustic transducers 12. The well logging instrument string 40 may be maintained substantially in the center of the casing 32 by the use of centralizers 22 having suitable internal and external dimensions.

FIG. 5 shows an upper portion of the well logging instrument string 40, which is located above the portion of the well logging instrument string shown in FIG. 4. The segment of the casing 32 which encloses the upper portion of the well logging instrument string 40 may be similar to other casing segments (e.g., 32 in FIG. 4) with respect to its outside diameter, but the part of the casing 32 enclosing the upper portion of the instrument string 40 may preferably have a reduced internal diameter to accommodate pressure barriers and a latching mechanism 30. Electronic components in this section of the casing 32 may include batteries 14 used to power the instrument string 40 to enable making measurements while moving the casing 32 into the wellbore. A fishing head 26 may be disposed at the top of the well logging instrument string 40 to enable retrieval of the instrument string 40 from the casing 32 after the casing 32 is inserted into the wellbore to its intended depth.

After completing the casing insertion, the instrument string 40 may be removed from the interior of the casing 32 using, for example, a wireline (an armored electrical cable) with an overshot, a slickline with an overshot, a small diameter segmented tubing or a coiled tubing. Any of the foregoing devices may be inserted into the casing 32 to latch the fishing head 26 and pull the instrument string 40 out of the casing 32. The fishing head 26 may have an integrated telemetry interface 28 so that data from the instrument string 40 can be retrieved from a data storage device therein (not shown separately) in case the instrument string 40 cannot be pulled out of the casing or liner 32. The telemetry interface 28 may, for example, be configured to electromagnetically communicate with a corresponding telemetry interface lowered into the casing 32 at one end of an armored electrical cable. An example of such communication interface is described in U.S. Pat. No. 4,901,069 issued to Veneruso and incorporated herein by reference. The well logging instrument string 40 may also have a local communication system forming part of the telemetry interface 28, for example, a fluid flow modulation system, to communicate selected measurements made by various sensors on the well logging instrument string to the surface during the insertion of the casing 32 into the wellbore. One such fluid flow modulation system is described in U.S. Pat. No. 4,814,609 to Wraight et al., incorporated herein by reference.

After retrieval of the well logging instrument string 40 from the casing 32, the casing 32 may be cemented in place using techniques known in the art.

As will be appreciated by those skilled in the art, the term “casing” typically describes a protective pipe inserted into a wellbore that extends to or proximate to the Earth's surface (or to the mud line in a subsea wellbore) from an intended depth in the wellbore. A casing may have a “wellhead” or similar device coupled to an upper end thereof upon completion of the wellbore construction. A “liner” typically describes a protective pipe that extends from an intended depth in the wellbore to a shallower depth in the wellbore, the shallower depth usually being close to the lowermost depth of a previously cemented liner or casing. It is to be clearly understood that the term “casing” as used herein may mean both a full length pipe “casing” as that term is ordinarily used and a shorter length “liner” as that term is ordinarily used. The invention is equally applicable to both casing and liner running operations. Therefore, the term “pipe” or “wellbore pipe” will be used herein to indicate that both casing and liner operations are within the scope of the invention.

A well logging instrument system according to the various aspects of the invention may enable wellbore operators to obtain open hole formation measurements where the cost of obtaining such measurements using other systems is prohibitive or excessively risky.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A well logging while casing instrument system, comprising:
a segment of pipe having at least one window therein corresponding to selected well logging instrument sensors, the segment of pipe having at least one of a float collar, reaming shoe or casing drill bit attached to one end thereof;
at least one well logging instrument disposed inside the segment of pipe, the at least one well logging instrument including at least one sensor disposed at longitudinal position corresponding to the at least one window.

2. The system of claim 1 further comprising a fishing neck at one longitudinal end of the well logging instrument to enable retrieval of the at least one well logging instrument from the interior of the segment of pipe.

3. The system of claim 1 wherein the at least one well logging instrument comprises one of electromagnetic propagation sensors, nuclear magnetic resonance sensors, gamma ray detectors, neutron detectors, galvanic electrodes, and acoustic transducers.

4. The system of claim 1 further comprising at least one centralizer disposed along the well logging instrument to maintain a lateral position thereof inside the wellbore pipe.

5. The system of claim 1 further comprising a telemetry interface associated with the at least one well logging instrument and configured to communicate data stored in the well logging instrument to a corresponding interface disposed at one end of an armored electrical cable.

6. The system of claim 1 further comprising at least one of a casing drill bit, a reaming shoe, a float collar and a bull-nose disposed at one end of the pipe segment.

7. A method for well logging, comprising:
inserting at least one well logging instrument into an interior of a segment of a wellbore pipe, the pipe having at least one window therein corresponding to a longitudinal position of a sensor on the at least one well logging instrument;
inserting the pipe into a wellbore drilled through subsurface formations to a selected depth therein;
operating the at least one well logging instrument to measure a physical property of the subsurface formations as the pipe is inserted into the wellbore.

8. The method of claim 7 further comprising retrieving the at least one well logging instrument from the segment of wellbore pipe when the wellbore pipe is inserted to the selected depth.

9. The method of claim 7 wherein the at least one well logging instrument comprises one of electromagnetic propagation sensors, nuclear magnetic resonance sensors, gamma ray detectors, neutron detectors, galvanic electrodes, and acoustic transducers.

10. The method of claim 7 further comprising communicating a value of the measured physical property to the surface while inserting the wellbore pipe.

11. The method of claim 7 further comprising operating at least one of a casing drill bit and a reaming shoe while inserting the pipe segment into the wellbore.
